(19) United States
(12) Patent Application Publication
(10) Pub. No.: US 2008/0082980 A1
(43) Pub. Date: Apr. 3, 2008

(54) SYSTEM AND METHOD FOR USING FILTERS AND STANDARDIZED MESSAGES TO IDENTIFY AND SCHEDULE APPOINTMENTS IN AGGREGATE RESOURCE SCHEDULING APPLICATIONS

(75) Inventors: Kevin S. Nessland, Bozeman, MT (US); Jerome L. Nettuno, Bozeman, MT (US)

Correspondence Address: ANTOINETTE M. TEASE, P. O. BOX 51016, BILLINGS, MT, 59105, US

(73) Assignee: Edge Inova International, Inc., Bozeman, MT (US)

(21) Appl. No.: 11/536,089

(22) Filed: Sep. 28, 2006

(51) Int. Cl. G06F 9/46

(52) U.S. Cl. 718/104

(57) ABSTRACT

A system for using filters and standardized messages to identify and schedule appointments, comprising: an aggregate resource scheduling database; application server software code; a web server; and a client-based resource scheduling filter; wherein the aggregate resource scheduling database contains resource and service information, appointment schedules and service provider information collected from service providers participating in an aggregate resource scheduling community; wherein the application server software code retrieves data from the aggregate resource scheduling database based on parameters applied by a client using the resource scheduling filter; wherein the web server brokers messages to and from the application server software code; and wherein the resource scheduling filter displays data retrieved from the aggregate resource scheduling database by the application server software code. A method of scheduling appointments using the system described above.

### BACKGROUND OF THE INVENTION

1. Field of the Invention

The present invention relates generally to the field of computer programs and, more specifically, to a system and method for using filters and standardized messages to identify and schedule appointments in aggregate resource scheduling applications.

2. Description of the Related Art

As use of the World Wide Web continues to increase, businesses have learned to leverage the Internet's near continuous availability to increase commerce. The stories of new and existing businesses rushing to sell tangible products online—books, DVDs, etc.—are well known and well documented. Providers of non-tangible services, however, have struggled to leverage the Internet as more than an “online yellow pages” or feature-rich service directory. While potential clients can and do use the Internet to identify names, addresses, phone numbers, and even physical locations of such service providers, it is only recently that software providers have begun offering Internet-based software applications that truly add value for this business segment.

One such application is resource-scheduling software. Using the web, service businesses can allow their clients to view scheduling calendars in real- or near-real-time. Some software applications even allow clients to schedule their own appointments over the Internet, providing a level of client service that improves client satisfaction and eliminates a tedious, time-intensive process for the business owner.

Resource scheduling software tracks appointments for both animate and inanimate resources. Animate resources are entities that provide a service—such as a barber who provides haircuts. Clients schedule appointments with an animate resource for a service that the resource provides. Inanimate resources do not provide services; instead, clients schedule appointments to use the inanimate resource itself (such as a tanning bed or basketball court).

Resource scheduling software typically allows a storeowner or manager to create database records for each resource or service the store makes available to its clients. The definition of the resource or service involves configuration of default duration, i.e., how long the resource will be in use each time it is booked or how long it will take to deliver the service. These settings are then used when scheduling the resources and services on a date and time calendar. The resource scheduling software allows receptionists, clients, or the individual delivering the service to quickly identify available time slots and upcoming appointments. Business rules in the resource scheduling software prevent duplicate booking of a particular resource or the scheduling of service delivery in a time-slot that is inadequate (for instance, the software will prevent a 45-minute haircut from being scheduled in a half-hour time slot on the calendar).

By making the date and time calendar available over a network—typically the Internet's World Wide Web—a business can allow its clients to browse the calendar for open appointment times for the resources or services that interest them. Once the client has identified an open time slot for the resources or service of interest, he or she can typically use the resource scheduling software to schedule an appointment in that time slot. The software saves these appointments to the resource scheduling software's database and updates the calendar accordingly.

Although such software works well for existing clients who know which stores offer the service or resource they wish to schedule, it is not as effective for new clients who desire to purchase a service but do not know which service providers in an area exist to provide it.

To address this problem, software systems have been developed to allow clients to review resource or service availability across several disparate service providers. As opposed to the single service provider perspective of regular resource scheduling software, these systems—referred to herein as “aggregate resource scheduling software systems”—allow clients to locate resources and services available from a community of participating service providers and then schedule appointments for those resources and services via a common user interface.

Aggregate resource scheduling software systems typically employ one of two architectural models: distributed systems that use data replication to pull data from disparate scheduling systems to create a single appointment scheduling database, or centralized systems with a single database that is used by both clients and disparate service providers for all scheduling. While distributed systems must either redirect clients to the service provider's scheduling software or address the issue of synchronizing new appointments made in the aggregate database with appointments scheduled in the distributed source systems, centralized systems do not have this problem because both clients and service providers schedule appointments using the same centralized database.

Regardless of the architecture, the purpose of aggregate resource scheduling software is twofold: first, to assist the client in identifying service providers that offer services and resources of interest; and second, to allow the client to review the service or resource appointment schedule after a service provider of interest has been identified.

A. Using Search to Identify Service Providers

In typical aggregate resource scheduling software implementations, clients make use of well-known search methodologies to query the aggregate database via a software application (typically presented in the form of a web page) for service providers that provide resources or services of interest (e.g., “Show me all ‘Health Clubs’ in ‘Topeka’ that offer a class in ‘Pilates’.”). Although this is an improvement over forcing the client to separately identify and navigate to individual service provider websites to review service and resource offerings, the process remains cumbersome because it assumes that the client will correctly guess the search terms under which the various service providers have been categorized in the aggregate resource scheduling software. Thus, a client search for ‘Fitness Centers’ in ‘Topeka’ that offer a class in ‘Pilates’ may return a different set of results than a similar query for ‘Health Clubs’. What is worse, the client is not aware that other, potentially more applicable results exist than those returned as a result of his or her query.

B. Scheduling Appointments Using Aggregate Resource Scheduling Software

When the client identifies a service provider that offers a resource or service of interest, the client must then determine if that resource or service is available in a time slot that is acceptable.

In systems that use a distributed architecture, the aggregate resource scheduling software may either redirect the client to the service provider's own scheduling application (typically, a separate website) or allow the client to review scheduling information and create an appointment using data available in the central database. Implementations that redirect the client to service provider websites for scheduling are problematic because the client may be redirected several times before he or she is able to find a service provider with an open time slot that is acceptable. Although distributed systems that allow the client to both search and schedule in the same application do not share this inconvenience, they do face the more complex problem of synchronizing data that is updated centrally with that updated locally by the service providers in their separate, standalone resource scheduling applications.

To function properly, distributed systems using this architecture must frequently replicate data bi-directionally to avoid “double-booking,” i.e. scheduling the same service or resource twice in the same time slot in separate software systems. As appointments are made in the separate service provider scheduling applications, this information must be forwarded to the centralized database so that clients querying the central database for open time slots receive accurate information. Likewise, as appointments are scheduled centrally, that data must be sent back to the service provider database to both notify the service provider of the new appointments and to avoid double booking in the service provider's scheduling software.

Unfortunately, the replication of data is not as simple as it sounds. Even with very frequent replication, the possibility exists that a time slot may have been double-booked in the separate software systems between replication events. Conflicts are inevitable, and software systems that share data in this manner must possess business logic that allows system users to review these conflicts and determine which appointment should be retained and which should be discarded. A discarded appointment requires communication with the losing client to inform him or her that the appointment must be rescheduled.

To address these weaknesses in distributed system architectures, some have adopted a centralized architecture where the aggregate resource scheduling software is made the single, authoritative source for all scheduled appointments: appointments can be scheduled only in the centralized scheduling application. While this model certainly solves the technical problems of data concurrency and synchronization, it is problematic because it forces service providers to abandon whatever resource scheduling software they may have been using formerly as a condition of joining the aggregate resource scheduling community. Service providers may be reticent to take this step if their existing resource scheduling software is highly functional or tightly integrated with their overall enterprise business management software. The end result is lower participation in the community, diminishing its effectiveness for clients seeking to schedule appointments for services and resources made available by service providers.

What is needed is a distributed aggregate resource scheduling solution that 1) allows clients to easily and effectively identify all service providers in a community that offer resources and services of interest; 2) enables the client to rapidly identify open time slots and schedule appointments without being redirected to individual service provider websites; 3) eliminates the possibility of double-booking services or resources; and (4) allows individual service providers to continue using whatever resource scheduling software applications they may have currently implemented.

### BRIEF SUMMARY OF THE INVENTION

The present invention is a system for using filters and standardized messages to identify and schedule appointments, comprising: an aggregate resource scheduling database; application server software code; a web server; and a client-based resource scheduling filter; wherein the aggregate resource scheduling database contains resource and service information, appointment schedules and service provider information collected from service providers participating in an aggregate resource scheduling community; wherein the application server software code retrieves data from the aggregate resource scheduling database based on parameters applied by a client using the resource scheduling filter; wherein the web server brokers messages to and from the application server software code; and wherein the resource scheduling filter displays data retrieved from the aggregate resource scheduling database by the application server software code.

In a preferred embodiment, the system further comprises service provider scheduling software; wherein the resource scheduling filter is used to identify resources in the aggregate resource scheduling database that are available for appointments using parameters set by the client; and wherein after the system applies the resource scheduling filter and returns the results to the client, a scheduling request message is sent directly from the client to the service provider scheduling software. Preferably, if there is no conflict between the scheduling request message and data in the service provider database, an appointment is scheduled directly in the service provider database. Preferably, if the scheduling request message conflicts with data in the service provider database, the system notifies the client that the appointment cannot be scheduled as requested.

In a preferred embodiment, each service provider has scheduling software, and the scheduling request message is formatted to appear as though it were created locally by the scheduling software in use by the service provider. Preferably, in the process of scheduling an appointment, the client is not redirected to an individual service provider website.

In a preferred embodiment, communication between the aggregate resource scheduling database and the service provider database is one-way in that data is transmitted from the service provider database to the aggregate resource scheduling database, but data is not transmitted from the aggregate resource scheduling database to the service provider database. Preferably, when scheduling information is added, deleted or modified in the service provider database, the service provider database triggers execute code in the form of SQL stored procedures that collect the new, modified or deleted data and send it to the aggregate resource scheduling database. Preferably, the SQL stored procedures modify the structure of the collected data so that it conforms to the schema of the aggregate resource scheduling database.

In a preferred embodiment, the system further comprises service provider scheduling software, the application server software code uses XML web services to retrieve data from the aggregate resource scheduling database, Simple Object Access Protocol messages are used to invoke the XML web services and receive data retrieved by the XML web services, and each Simple Object Access Protocol message comprises a payload selected from the group consisting of: invocation parameters set by the client using the resource scheduling filter, data retrieved by the XML web services from the aggregate resource scheduling database and sent back to the client, and an appointment scheduling request that is sent directly from the client to the service provider scheduling software.

In one embodiment, the data that is retrieved from the aggregate resource scheduling database is displayed to the client as a browser-based web page. In another embodiment, the data that is retrieved from the aggregate resource scheduling database is displayed to the client as a personal calendar agent.

In a preferred embodiment, the resource scheduling filter comprises one or more of the following: a geographic location filter, a date/time filter, an industry segment filter, a service provider filter, a resource filter, a service type filter, and a service filter. Preferably, the various filters that comprise the resource scheduling filter can be applied in any order.

In one embodiment, the date/time filter is applied by using date and time fields from a browser-based web page. In another embodiment, the date/time filter is applied using a personal calendar agent. In yet another embodiment, the date/time filter comprises a date/time range filter that allows the client to select a date and time range rather than a single date and time.

In a preferred embodiment, the system further comprises a list box that lists available appointments for a selected resource or resource/service combination when the client applies the date/time range filter. Preferably, the system further comprises a list box that lists appointments previously scheduled using the resource scheduling filter. Preferably, the system further comprises a list box that provides a view of all filters currently applied and allows the client to remove an applied filter by selecting a filter layer that is higher than that of the filter to be removed.

The present invention also encompasses a method of scheduling appointments, comprising: compiling resource and service information, appointment schedules and service provider information in an aggregate resource scheduling database; applying filter criteria to identify available appointments; using a client-based resource scheduling filter to apply the filter criteria; generating filter results; sending the filter results to the client; and sending a scheduling request message directly from the client to the service provider scheduling software to schedule the appointment; wherein the filter criteria are applied by a client desiring to schedule an appointment; and wherein the resource scheduling filter comprises one or more of the following: a geographic location filter, a date/time filter, an industry segment filter, a service provider filter, a resource filter, a service type filter, and a service filter.

In a preferred method, the method further comprises notifying the client that the appointment cannot be scheduled as requested if the scheduling request message conflicts with data in the service provider database. Preferably, each service provider has scheduling software, and the scheduling request message is formatted to appear as though it were created locally by the scheduling software in use by the service provider.

In a preferred embodiment, updated scheduling information is transmitted from the service provider database to the aggregate resource scheduling database but not from the aggregate resource scheduling database to the service provider database. Preferably, the method further comprises modifying the structure of data collected from the service provider database so that it conforms to the database schema of the aggregate resource scheduling database.

In a preferred embodiment, the method further comprises using XML web services to retrieve data from the aggregate resource scheduling database. Preferably, the method further comprises using Simple Object Access Protocol messages for communications between the aggregate resource scheduling database and the client and for communications between the client and the service provider scheduling software; wherein each Simple Object Access Protocol message comprises a payload selected from the group consisting of: invocation parameters set by the client using the resource scheduling filter, data retrieved by the XML web services from the aggregate resource scheduling database and sent back to the client, and an appointment scheduling request that is sent directly from the client to the service provider scheduling software.

In one embodiment, the method further comprises displaying the filter results to the client in a browser-based web page. In another embodiment, the method further comprises displaying the filter results to the client in a personal calendar agent.

In a preferred embodiment, the filters that comprise the resource scheduling filter can be applied in any order. In one embodiment, the date/time filter is applied by using date and time fields from a browser-based web page. In another embodiment, the date/time filter is applied using a personal calendar agent. In yet another embodiment, the date/time filter comprises a date/time range filter that allows the client to select a date and time range rather than a single date and time.

In a preferred embodiment, the method further comprises providing a list box that lists available appointments for a selected resource or resource/service combination when the client applies the date/time filter. Preferably, the method further comprises providing a list box that lists appointments previously scheduled using the resource scheduling filter. Preferably, the method further comprises providing a list box that provides a view of all filters currently applied and allows the client to remove an applied filter by selecting a filter layer that is higher than that of the filter to be removed.

### BRIEF DESCRIPTION OF THE DRAWINGS

FIG. 1 is a diagram of a preferred embodiment of the network architecture of the present invention.

FIG. 2 is a diagram of a preferred embodiment of the server software architecture of the present invention.

FIG. 3 is a diagram of a preferred embodiment of the user interface of the client software of the present invention.

### REFERENCE NUMBERS

1 Datacenter (aggregate resource scheduling software and database) of present invention
2 Data feed from service provider database to database of present invention
3 Service provider datacenter (resource scheduling software and database)
4 Clients (web browsers) of present invention
5 SOAP (Simple Object Access Protocol) messages (appointment requests and error messages)
6 SOAP messages (requests for data)
7 HTTP web server that sends and receives SOAP messages and brokers SOAP message contents to XML web services
8 SOAP message payload requesting filtered or unfiltered data
9 XML web services that get data from the database and apply specified filtering parameters
10 SQL (Structured Query Language) stored procedures executed by the XML web services to get data from the database
11 Database of the present invention that contains store, service, resource, appointment, and user information
12 Filtered datasets retrieved and sorted by XML web services
13 Message from XML web services to HTTP server with filtered data ready to be returned to the client
14 Geographic location filter
15 Input fields (name and ZIP Code) for positioning in the list of available communities
16 Date/time filter input fields
17 Any date/time check box
18 Industry segment filter
19 Service provider filter
20 Name input field for positioning in a list
21 Sort dropdown list
22 Back and Forward buttons for paging through a list
23 Resource filter
24 Service type filter
25 Service filter
26 Available time slots
27 Set Reservation button
28 Historical reservations list
29 Selected filter parameters

### DETAILED DESCRIPTION OF INVENTION

The present invention is aggregate resource scheduling software that replaces the search mechanisms of previous aggregate scheduling solutions with a filtering mechanism that immediately exposes to the client all possible appointment times for all industry segments, stores, resources, and services available in a given community of participating businesses. This filtering mechanism allows the client to identify services and appointment time slots of interest more readily because the client does not have to guess the right search terms that will return hits of interest. Rather than using a search mechanism to hunt for possible matches, the client uses the filtering mechanism to eliminate presented options that do not match his or her needs. By starting with the universe of acceptable filtering criteria, the client is able to hone in on the service and resource of interest more readily than when starting with an empty universe and attempting to populate it using a search-based mechanism that relies on valid search terms the client may not know. Additionally, the filtering mechanism of the present invention integrates time slot parameters as part of the filter, allowing the client to specify acceptable schedule openings as part of the filtering process. This approach avoids the redirection of the client to separate websites for schedule queries and appointment booking that is prevalent in other solutions.

Further, the present invention avoids the problems of data concurrency and synchronization not by replacing a distributed architecture with a centralized architecture, but instead by sending standardized scheduling messages from the aggregate resource scheduling system of the present invention to the separate resource scheduling systems in use by participating service providers. These standardized scheduling messages are formatted to appear as if they were created locally by the scheduling software in use at the service provider's site; as a consequence, they are processed and subjected to the same business rules as an appointment request created locally. This allows the present invention to provide the client with immediate feedback regarding scheduling success. Even if the data on file in the centralized database indicates that a time slot is open, any possibility of double booking as a result of out-of-date data is eliminated because the service provider's own scheduling software processes the scheduling request message. If the requested time slot contained in the scheduling request message conflicts with data in the service provider's database, the aggregate resource scheduling system of the present invention notifies the client that the appointment cannot be scheduled as requested. Thus, the present invention provides the benefits of a centralized solution while retaining the flexibility of a distributed architecture.

A. Network Architecture of the Present Invention

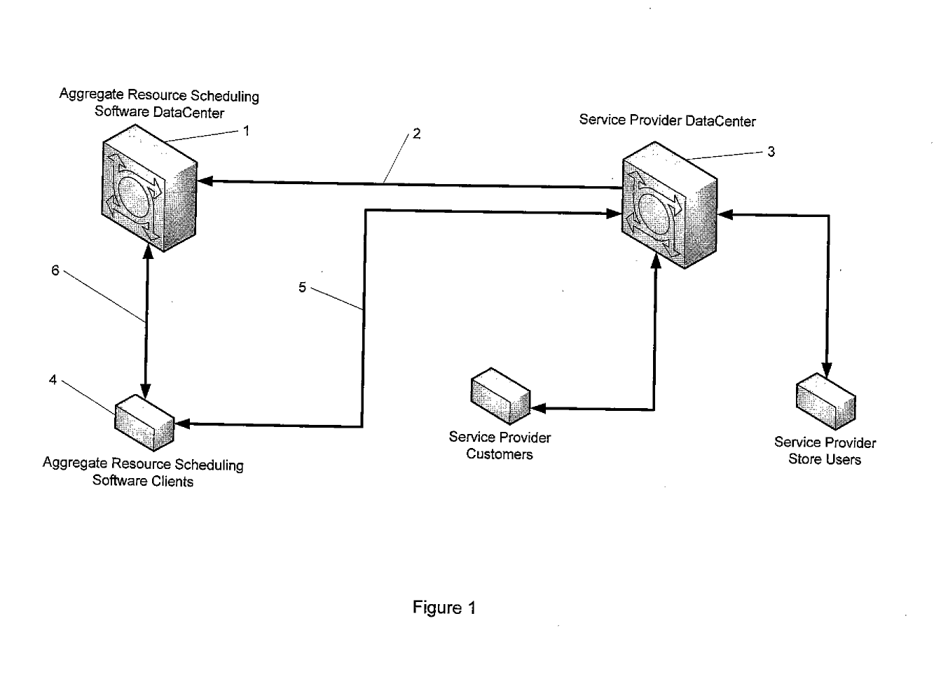

FIG. 1 is a network architecture diagram of a preferred embodiment of the present invention. This diagram shows the datacenter of the present invention, the datacenter of a service provider, and the one-way communication from the service provider data center to the datacenter of the present invention. This diagram also shows the two-way communication between clients of the present invention and the service provider datacenter.

A preferred embodiment includes an HTTP server, application server, and database server running at a central datacenter (1). This datacenter receives data from disparate service provider datacenters (3) over a network connection (2). In a preferred embodiment, the central datacenter (1) also receives requests for filtered service provider, resource, and service data from web-based clients (4) via SOAP messages (6). The web-based clients (4) also send SOAP messages containing appointment requests (5) directly to XML web services running at the disparate service provider datacenters (3).

B. Software Architecture of the Present Invention

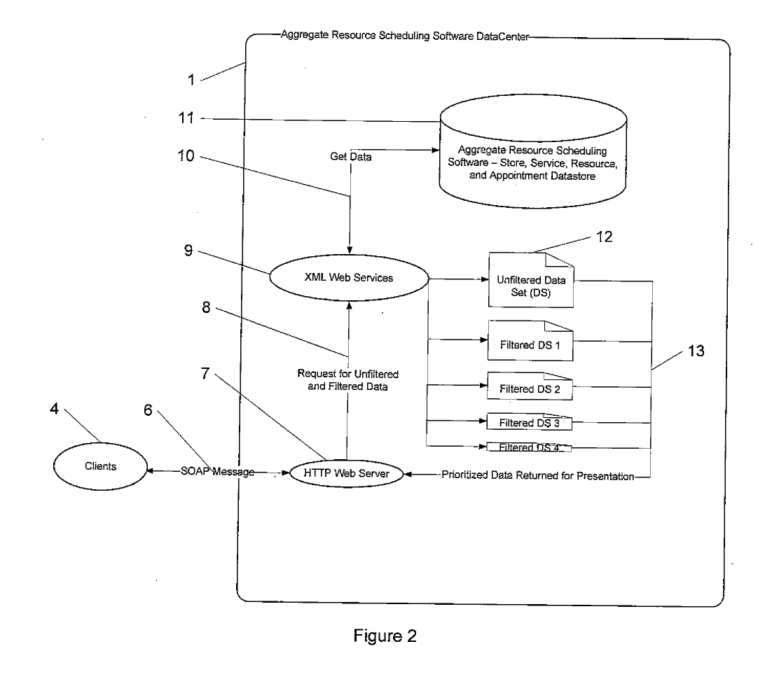

FIG. 2 is a diagram of the current invention's software architecture. This diagram shows an HTTP server that receives requests from clients and brokers requests for data to the XML web services. The XML web services retrieve data from the database and apply requested filters to it. The XML web services send the filtered datasets back to the HTTP server, which then packages the data and sends it back to the requesting client.

As shown in FIG. 2, the present invention consists of a database (11), application server software code (9) used to retrieve data from the database (11), a web server (7) that brokers messages to and from the application server software code (9), and a resource scheduling filter that runs as a web page (4). These web browser-based clients (4) display data retrieved from the database (11) by the application server software (9). The server-side application elements reside on one or more database, application, and web PC servers hosted at a central location (1).

1. Database

The present invention's database (11) contains resource and service information, appointment schedules, and service provider information collected from the service providers (3) participating in the aggregate resource scheduling community. The database also includes other tables for storing client information, such as user name and password, e-mail address, and historical appointment information.

To create the database, the aggregate resource scheduling software system must consolidate data from individual service providers. In a preferred embodiment, special software code is installed on the computer that houses the service provider's scheduling database (3) when a service provider joins the community of participating businesses. This software code uses a known mechanism of executing one or more database triggers when events of interest occur to specific database tables in the service provider's resource scheduling software (such as the insert, edit, or delete of a resource or service, the insert or delete of an appointment, an edit of store hours of operation, a change to a resource or service's default duration, etc.). The database triggers execute code in the form of SQL stored procedures that collect the new, modified, or deleted data and send that data across the network (2) to the datacenter of the present invention's aggregate resource scheduling software (1). In a preferred embodiment, these stored procedures also modify the structure of the collected data so that it conforms to the database schema of the destination database, which has been de-normalized to improve the performance of the present invention's filtering mechanism.

A service provider is not required to use resource scheduling software manufactured by the creator of the present invention to make its scheduling information available to the aggregate resource scheduling community, provided that the service provider's software stores its data in a standard SQL database whose schema is available for review. To successfully receive appointments from the aggregate resource scheduling software of the present invention, the service provider's software must also expose an interface to its appointment scheduling mechanism.

Because data in the present invention's database is time-sensitive (i.e., appointments older than yesterday are no longer relevant), the system can purge expired data from the centralized database periodically to improve overall system performance and scalability.

2. Application Server Software Code

The application server software code includes XML web services (9) that get data from the present invention's database (11) based on parameters applied by the client using the invention's resource scheduling filter (4). A web service is an application that does not have a user interface, but instead is invoked over a local or wide area network by other software to accomplish work. Because web services are modular, self-describing, and based on such Internet standards as XML, HTTP, and SMTP, the invoking software need not be written in the same programming language nor run on the same operating system to make use of the web service. Thus, although one embodiment of the present invention invokes XML web services written in the C# programming language from a web browser-based filtering mechanism written in Ajax and JavaScript, the present invention's client interface is not limited to this implementation. Instead, by way of example but not limitation, the XML web services of the present invention could be invoked from a calendaring application written in C++ running on a Microsoft Windows thick client, an appointment scheduling Java applet running on a Unix client, a maintenance script written in Perl and executed from a Linux client's command-line environment, or a personal calendar application running on a cell phone or other mobile device.

A preferred embodiment uses SOAP (Simple Object Access Protocol) messages (6) to invoke the XML web services (9) and receive data retrieved by them (12). This standardized messaging format works well in the web-based environment of the present invention because it leverages Hypertext Transfer Protocol (HTTP) as its communication mechanism. HTTP is a well-known, standardized protocol that is supported across operating systems and passes freely through most firewalls. Consequently, the configuration requirements for clients using the preferred embodiment are slight—any client with web access and an appropriate web browser is able to use the present invention.

Although SOAP messages are used in a preferred embodiment, the XML web services (9) of the present invention may also be invoked using a variety of other, well-known invocation mechanisms, such as RPC (Remote Procedure Call).

The payload, or contents, of a SOAP message is data marked up in XML (Extensible Markup Language). In a preferred embodiment, the SOAP payload is either: 1) invocation parameters (8) set using the present invention's resource scheduling filter (4) for the XML web services (9) that reside on the present invention's application server; 2) data (12) retrieved by the XML web services (9) that is sent back to the client-based resource scheduling filter (4) for presentation to the client; or 3) an appointment scheduling request (5) sent from the client-based resource scheduling filter (4) to the service provider's resource scheduling software datacenter (3). The purpose and payload of SOAP messages are not limited to these preferred embodiments.

3. Client Software Code

In a preferred embodiment, the present invention's resource scheduling filter (4) is presented to the client as a browser-based web page built using Ajax and JavaScript. In another preferred embodiment, the client interface is a personal calendar agent that acts as an add-on to the client's personal calendaring software. This agent sends filtering parameters to the XML web services of the present invention's application layer (9) and receives results (12) from those same services for presentation to the client. These embodiments are not intended to be exhaustive, as the XML web services of the present invention may be invoked from a variety of client interfaces running on various operating systems and written in various programming languages.

4. Service Provider Elements

When a service provider joins the present invention's aggregate resource scheduling community, an installation routine installs one or more XML web services on the application server at the service provider's datacenter (3). These XML web services are responsible for updating the service provider's resource scheduling database with appointment requests received from the present invention's resource scheduling filter (4). The installation routine also installs and executes several stored procedures that copy existing resource, service, appointment, and service provider data and send it (2) from the service provider datacenter (3) to the present invention's centralized datacenter (1).

C. The Resource Scheduling Filter

i. Overview

In one embodiment, the present invention presents its resource scheduling filter (4) in the form of a web page that can be displayed on any device capable of running a current web browser. In this embodiment, to begin using the resource scheduling filter (4), the client navigates to the appropriate web page using a provided URL (Uniform Resource Locator). In another embodiment, the present invention presents its resource scheduling filter (4) in an application window accessed directly from a client's personal calendaring software. Other embodiments are possible, provided the device/software used as the resource scheduling client can invoke and consume output from the XML web services (9) of the present invention.

The resource scheduling filter (4) allows clients to quickly identify services and resources of interest and then schedule an appointment to purchase or use those services or resources.

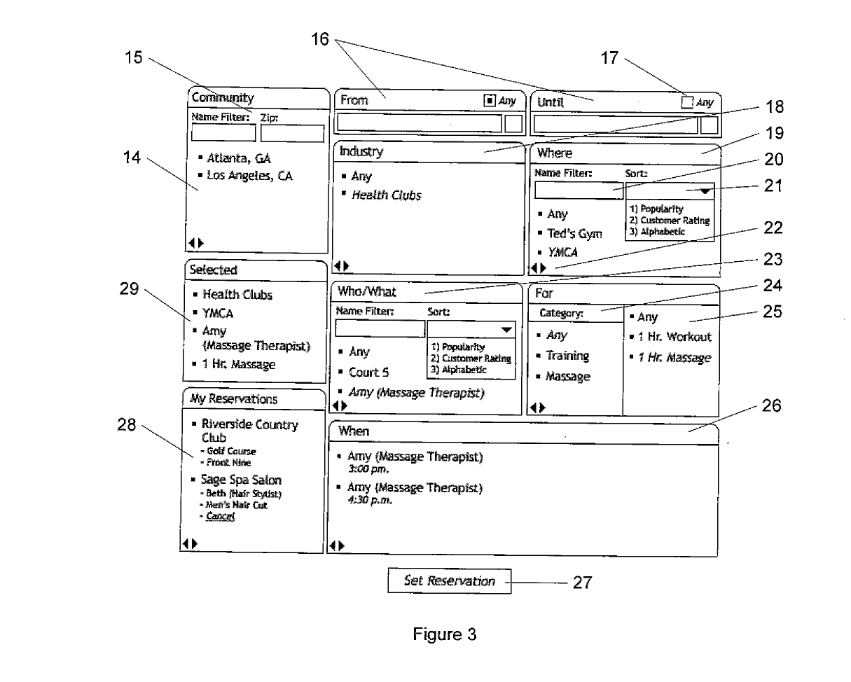

FIG. 3 is a diagram of the present invention's resource scheduling filter (4). In a preferred embodiment, clients can apply any of the following filters:

Geographic Location (14)

Date/Time (16)

Industry Segment [e.g., fitness center, restaurant, spa, etc.] (18)

Service Provider [store name] (19)

Resource [animate or inanimate resources] (23)

Service Type [e.g., haircut, massage, etc.] (24)

Service [e.g., deep tissue massage, warm stone massage, etc.] (25)

Clients can apply filters alone or in tandem. Consider a date/time filter (16) of “Aug. 6, 2006 at 2:00 PM.” When the client applies this filter, the system hides any industry segments (18), service providers (19), resources (23), service types (24), and services (25) that do not have an open time slot at 2:00 PM on the 6^{th} of August. The client might then select a service provider from the “Where” list box (19). The system applies this filter to hide all industry segments (18) that do not match the industry segment(s) of the selected service provider. The system also hides any service type (24) or service (25) that is not available for purchase from the selected service provider in the 2:00 PM time slot on Aug. 6, 2006. Finally, the system hides any resource (23) not affiliated with the selected service provider and shows only those resources with open appointments at 2:00 PM on Aug. 6, 2006.

Clients can apply filters in any order. Perhaps a client wants to identify all service providers who offer deep tissue massage. When the client selects “Massage” from the category column (24) in the “For” list box, the system hides all service providers (19) and resources (23) that do not provide massage services. Next, the client selects “Deep Tissue Massage” from the service list (25) in the “For” list box. The system hides all service providers (19) and resources (23) that do not provide deep tissue massage. The client can now either choose a service provider (19) to see a list of resources (23) that provide deep tissue massage at that particular location, or simply select a resource (23) and schedule an appointment.

The resource scheduling filter includes the following elements:
“Community” list box (14)—Used to apply a geographic location filter.
“From/Until” input fields (16)—Used to apply a date/time filter, or specify that no date/time filter should be applied [signified by selecting the “Any” checkbox (17)].
“Industry” list box (18)—Used to apply an industry segment filter and display the industry segment(s) of the listed service provider(s) (19).
“Where” list box (19)—Used to apply a service provider filter and display the service provider(s) associated with a selected industry segment (18), resource (23), service type (24), or service (25). Clients can position in this list alphabetically using the “Name” input field (20). In a preferred embodiment, the system sorts items in this list alphabetically. Alternatively, clients can choose to sort this list (21) by popularity (based on the number of scheduled appointments) or by client rating (based on an average score calculated from client feedback).
“Who/What” list box (23)—Used to apply a resource filter and display the resources associated with a selected industry segment (18), service provider (19), service type (24), or service (25). Clients can position in this list alphabetically using the “Name” input field (20). In a preferred embodiment, the system sorts items in this list by popularity (based on the number of scheduled appointments). Alternatively, clients can choose to sort this list (21) alphabetically or by client rating (based on an average score calculated from client feedback).
“For” list box—Used to apply service type (24) and service (25) filters. Displays the service categories and services associated with a selected industry segment (18), service provider (19), or resource (23). Clients can also position in the service list alphabetically using the “Name” input field (20).
“When” list box (26)—Lists the available appointments for a selected resource (23) or resource/service combination (23, 25). This list is not populated if the client applies a single date/time filter, but will be populated if the client applies a date/time range filter (16).
“My Reservations” list box (28)—Lists appointments previously scheduled using the resource scheduling filter. Selecting an item from this list pre-populates the service provider and resource “Name” input fields (20) with positioning criteria to assist the client in locating a resource or resource/service that he or she previously scheduled.
“Selected” list box (29)—Provides a view of all filters currently applied and allows the client to remove an applied filter by selecting a filter layer that is higher than that of the filter to be removed.

### The client can “collapse” filter list boxes to hide them from view if he or she is not interested in reviewing or applying filters from the collapsed list.

ii. Filtering Mechanism—Technical Details

In a preferred embodiment, the resource scheduling filter is presented to the client via a web page built with Ajax and JavaScript (4). On the page's initial load, software code in the client web page creates one or more SOAP messages (6) containing the selected location filter (14), the default date/time filter (16), and a request for the first twenty (20) matching records (configurable in system setup) in each of the following categories:

Industry segment (18)

Service provider (19)

Resource (23)

Service category (24)

Service (25)

The client software (4) sends the SOAP message(s) (6) to the HTTP server running at the data center (7). The HTTP server (7) opens the SOAP message(s) (6) and delivers the payload (8)—in this case, method calls with client-specified filtering parameters—to the filter.asmx XML web service (9). This XML web service (9) retrieves records that match the filter parameters (8) from the present invention's database (11) using Structured Query Language (SQL) stored procedures (10). After the XML web service (9) has retrieved the required data (12) and applied the appropriate filters and sorts, it sends (13) the data back to the HTTP server (7) for delivery to the client (4). The HTTP server (7) receives the message (13), packages the filtered dataset (12) into one or more outgoing SOAP messages (6), and then sends the SOAP message(s) back to the waiting web browser (4). Software code in the web page opens the SOAP message(s) (6) and processes the payload (i.e., the filtered datasets (12)) for presentation to the client via the resource scheduling filter's user interface (4).

The sequence of sending SOAP messages (6) back and forth to update the data displayed in the resource scheduling filter (4) is repeated each time the client:
Applies or removes a data filter (14, 16, 18, 19, 23, 24, 25);
Changes the sort order of a displayed list (21);
Attempts to position within the list of service providers or resources using the “Name” input field (20); or
Pages backward or forward through the list of service providers, resources, services, available times, or historical appointments using the supplied Back (<) and Forward (>) buttons (22).

iii. Filtering Mechanism—Elements

a. “Community” List Box (14) [Geographic Location Filter]

The first time a client accesses the resource scheduling filter of the present invention, the client must select a geographic location of interest. In a preferred embodiment, the user selects a location from a list of locations (14) participating in the aggregate resource scheduling community. The selected location becomes the first filter applied to the list of stores, resources, and services available in the community.

In another preferred embodiment, the user positions in the list of participating communities (14) using location name or ZIP Code (15). The resource scheduling filter (4) creates a SOAP message (6) containing the supplied parameters and sends this data to the HTTP server (7) running at the central datacenter (1). The HTTP server (7) opens the SOAP message (6) and brokers its payload (8) to the filter.asmx XML web service (9), which queries the database (11) and returns a list of participating communities (12) that are geographically closest to the supplied search parameters (either name or ZIP Code). The HTTP server (7) packages this data in an outgoing SOAP message (6) and returns it to the requesting web browser for presentation to the client. The client then chooses one location from the list returned by the query. The selected location becomes the first filter applied to the list of service providers, resources, and services available in the community.

The system saves the selected location as the default location filter for the client. The client can change the location filter at any time by selecting another location from the list using the procedure outlined above.

b. “From/Until” Fields (16) [Date/Time Filter]

In a preferred embodiment, the client uses the “From” and “Until” date/time fields (16) to specify date and time filters to be applied to the lists of available service providers (19), resources (23), service categories (24), and services (25). In another preferred embodiment, date and time filtering parameters are passed to the present invention from a personal calendar agent running on the client's desktop. The system applies the date and time filter specified by the client (e.g., “Date/time filter=‘Dec. 3, 2006 at 2:00 PM’”) to show only those service providers (19), resources (23), service categories (24), and services (25) that are open for scheduling at that date and time. Alternatively, the client can specify a date and time range (e.g., “Date/time filter=‘Any time between Dec. 3, 2006 at 2:00 PM and Dec. 5, 2006 at 5:00 PM’”). The resource scheduling filter will apply this date and time range filter to the available dataset and display only those service providers (19), resources (23), service categories (24), services (25), and open time slots (26) available for scheduling in the specified date and time range. A third option is to select the “Any” checkbox (17). When the client selects this checkbox, the system does not apply any date/time filter to the service provider (19), resource (23), service category (24), or service (25) lists.

### In a preferred embodiment, the system applies a default date/time range filter of current date/time+48 hours when the client launches the resource scheduling filter.

c. “Industry” List Box (18) [Industry Segment Filter]

In a preferred embodiment, the “Industry” list box (18) displays a list of industry segments. When the client selects an entry from this list (18), the system applies an industry segment filter to the list of service providers (19), resources (23), service categories (24), and services (25) and shows only those entries that are associated with the selected industry segment. In a preferred embodiment, the list of industry segments includes:
Any (selected by default)—Selection of this option indicates that the resource scheduling filter will apply no industry segment filter to the displayed data.
Tanning salons
Day spas
Health clubs
Golf courses
Physical/massage therapists
Personal trainers
Restaurants
   This list should not be considered exhaustive, as additional industry segments can and will be added to the system over time. A service provider can belong to more than one industry segment.

d. “Where” List Box (19) [Service Provider Filter]

In a preferred embodiment, the “Where” list box (19) displays a list of service providers participating in the aggregate resource scheduling community. Items in this list will change based on the applied industry segment (18), resource (23), service category (24), or service (25) filter. When the client selects a store from this list (19), the system updates the list of industry segments (18), resources (23), service categories (24), and services (25) and shows only those entries that are associated with the selected store. This list includes an “Any” option that is selected by default. Selection of this option indicates that the resource scheduling filter will not apply a service provider filter to the displayed data. Clients can scroll through the list of service providers using Back and Forward buttons (22), position in the list by typing alphanumeric characters in the “Name” field (20), and sort the list alphabetically, by popularity, or by rating (21).

e. “Who/What” List Box (23) [Resource Filter]

In a preferred embodiment, the “Who/What” list box (23) displays a list of resources available in the aggregate resource scheduling community. The list includes both animate (hair stylists, manicurists, etc.) and inanimate (racquet ball courts, tanning beds, etc.) resources. Items in this list (23) will change based on the applied industry segment (18), service provider (19), service category (24), or service (25) filter. When the client selects a resource, the system applies the filter to the industry segment (18), service provider (19), service category (24), and service (25) lists to show only those entries that are associated with the selected resource. This list includes an “Any” option that is selected by default. Selection of this option indicates that the resource scheduling filter will not apply a resource filter to the displayed data. Clients can scroll through the list of resources using Back and Forward buttons (22), position in the list by typing alphanumeric characters in the “Name” field (20), and sort the list alphabetically, by popularity, or by rating (21).

Clients create appointments to use inanimate resources; if the resource of interest is an animate resource, the client must also select a service (25) offered by that resource (23) before scheduling an appointment.

f. “For” List Box [Service Category Filter/Service Filter]

In a preferred embodiment, the “For” list box has two columns—category (or type) (24) and service (25). The category column (24) displays a list of service categories, while the service column (25) displays a list of services provided by stores participating in the aggregate resource scheduling community. Items in these columns will change based on the applied industry segment (18), service provider (19), or resource (23) filter. When the client selects a service category (24), the system updates the service column (25) to display services in that service category and filters the industry segment (18), service provider (19), and resource (23) lists to show only those entries that are associated with the selected service category. When the client selects a service (25), the system applies a service filter to the industry segment (18), service provider (19), and resource (23) lists to show only those entries that offer the selected service. Both columns include an “Any” option that is selected by default. Selection of this option indicates that the resource scheduling filter will not apply a service category or service filter to the displayed data. Clients can scroll through the list of services using Back and Forward buttons (22).

g. “When” List Box (26) [Available Times]

The “When” list box (26) displays a list of times when the selected resource (23) or resource/service combination (23, 25) is available for scheduling. This list box (26) is populated only if the user has specified a range of acceptable dates and times (16), or if the user has selected the “Any” date/time check box (17) to indicate that a date/time filter should not be applied to the data in the resource scheduling filter. Further, this list box is populated only after the client applies a resource filter (23) (for inanimate resources) or a resource and service filter (23, 25) (in the case of animate resources). Clients can scroll through the list of available times using Back and Forward buttons (22).

h. “My Reservations” List Box (28) [Appointment History]

The “My Reservations” list box (28) displays appointments that the client has previously scheduled using the present invention's resource scheduling filter. This list provides a convenient method for the client to create a new appointment for a resource or service that was scheduled in the past. When the client selects an entry displayed in “My Reservations” list box (28), the system lifts whatever filters may currently be applied—with the exception of the date/time filter (16)—and pre-populates the service provider (19) and resource (23) “Name” fields (20) with values from the historical appointment. The system populates the “My Reservations” list box (28) only if the client is logged in to the present invention's resource scheduling filter with a valid user account. Clients can scroll through the list of historic appointments using Back and Forward buttons (22).

i. “Selected” List Box (29) [Applied Filters]

The “Selected” list box (29) provides a contextual view of all filters currently applied using the resource scheduling filter and provides a rapid means for the client to remove one or more applied filters by selecting a filter layer that is higher than that of the filter to be removed. When a client loads the resource scheduling filter, the system applies geographic location (14) as the first filter. As the client drills down to isolate the resource or service he or she would like to schedule, the list of entries in the “Selected” list box (29) grows. At any point, the client can click an entry in the “Selected” list (29) to revert to a dataset to which only the selected filter and any filters listed above it have been applied.

For example, consider a client—Martha—who would like to schedule a manicure. After selecting a geographic location (14), Martha might specify a date and time (16), and then select a service category filter (25) of “Manicure.” This filter will update the “Where” list box (19) with all stores that provide manicures in the time frame Martha has specified. Now, perhaps Martha has heard about a particularly talented nail tech—Julie—at Special Spa, a spa frequented by several of Martha's friends. Martha selects Special Spa in the “Where” list box (19) to apply a service provider filter. After the system applies this filter, Martha notices that Julie's name does not appear in the list of available resources (23)—indicating that Julie is either booked or not working in the time slot Martha specified in filter #2. Martha has heard that Julie also works part-time at another spa across town, and she wonders if changing her service provider filter (19) to the other spa might find an open appointment. Martha clicks the “Manicure” entry in the “Selected” list box (29) to remove the “Where=‘Special Spa’” filter, locates the other spa in the list of service providers (19), and applies the new service provider filter to discover that Julie does indeed have an open appointment at the time requested.

iv. Scheduling an Appointment—Overview

When the client specifies a particular date and time using the date/time filter (16), the system displays only those resources (23) and resource/service combinations (23, 25) that are available for scheduling during that time slot. Thus, once the user selects a resource (in the case of inanimate resources) or a resource and service (in the case of animate resources), he or she is ready to schedule an appointment.

If the client specified a date and time range (16) or chose not to apply a date/time filter by selecting the “Any” date/time checkbox (17), the client must also select an entry from the “When” list box (26) after selecting a resource (23) or resource/service combination (23, 25). The system will attempt to schedule an appointment using the time slot the client selects in the “When” list box (26).

When the client has selected the date, time, and resource or resource/service combination to be scheduled, he or she clicks the Set Reservation button (27) to create an appointment.

If the client has not previously logged in to the resource scheduling filter, the system will prompt the client to log in when he or she attempts to create an appointment. If the client does not have a user account, the system provides an opportunity to create one at this time. User accounts include the client's name, e-mail address, and password. The system uses the client's name and e-mail address when passing appointment information to the resource scheduling software in use at the service provider's location.

v. Scheduling an Appointment—Technical Details

The following describes a preferred embodiment of the present invention. When the client clicks the “Set Reservation” button (27) and logs in using his or her user account, software code in the client web page creates a SOAP message (6) containing details of the appointment to be scheduled, including:

Client identifier

Client name

Client e-mail

Resource to be scheduled

Service to be scheduled (if applicable)

Date and time to be scheduled

Service provider identifier

Using service provider identification data stored in the aggregate resource scheduling software database (11), the resource scheduling filter (4) sends this SOAP message over the network (5) to the service provider's HTTP server. This HTTP server unpacks the SOAP message and brokers the appointment-scheduling request to the reservations.asmx XML web service that was installed on the service provider's application server at system setup. Depending on the implementation, this XML web service may either run the appropriate method to create an appointment using the parameters provided in the SOAP message or modify the incoming appointment request's format so that it can be passed to the appointment scheduling mechanism used in the service provider's resource scheduling software. Because the reservations.asmx XML web service formats the foreign appointment request the same as one created locally, the service provider's resource scheduling software can use the same business rules and logic checks for both appointment request types.

If the data in the aggregate resource scheduling software's centralized database (11) is no longer current and a scheduling conflict is detected when the service provider's local resource scheduling software attempts to create an appointment, the reservations.asmx XML web service on the service provider's application server will send an error in a SOAP message (5) back to the resource scheduling filter (4) that requested the appointment. This error message notifies the client that his or her appointment request was not created successfully. The client can then select another open time slot to repeat the appointment request process.

Although the preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

We claim:

1. A system for using filters and standardized messages to identify and schedule appointments, comprising:
(a) an aggregate resource scheduling database;
(b) application server software code;
(c) a web server; and
(d) a client-based resource scheduling filter;
wherein the aggregate resource scheduling database contains resource and service information, appointment schedules and service provider information collected from service providers participating in an aggregate resource scheduling community;
wherein the application server software code retrieves data from the aggregate resource scheduling database based on parameters applied by a client using the resource scheduling filter;
wherein the web server brokers messages to and from the application server software code; and
wherein the resource scheduling filter displays data retrieved from the aggregate resource scheduling database by the application server software code.

2. The system of claim 1, her comprising service provider scheduling software;
wherein the resource scheduling filter is used to identify resources in the aggregate resource scheduling database that are available for appointments using parameters set by the client; and
wherein after the system applies the resource scheduling filter and returns the results to the client, a scheduling request message is sent directly from the client to the service provider scheduling software.

3. The system of claim 2, wherein if there is no conflict between the scheduling request message and data in the service provider database, an appointment is scheduled directly in the service provider database.

4. The system of claim 2, wherein if the scheduling request message conflicts with data in the service provider database, the system notifies the client that the appointment cannot be scheduled as requested.

5. The system of claim 2, wherein each service provider has scheduling software, and
wherein the scheduling request message is formatted to appear as though it were created locally by the scheduling software in use by the service provider.

6. The system of claim 2, wherein in the process of scheduling an appointment, the client is not redirected to an individual service provider website.

7. The system of claim 1, wherein communication between the aggregate resource scheduling database and the service provider database is one-way in that data is transmitted from the service provider database to the aggregate resource scheduling database, but data is not transmitted from the aggregate resource scheduling database to the service provider database.

8. The system of claim 7, wherein when scheduling information is added, deleted or modified in the service provider database, the service provider database triggers execute code in the form of SQL stored procedures that collect the new, modified or deleted data and send it to the aggregate resource scheduling database.

9. The system of claim 8, wherein the collected data comprise a structure, wherein the aggregate resource scheduling database comprises a schema, and wherein the SQL stored procedures modify the structure of the collected data so that it conforms to the schema of the aggregate resource scheduling database.

10. The system of claim 1, further comprising service provider scheduling software,
wherein the application server software code uses XML web services to retrieve data from the aggregate resource scheduling database;
wherein Simple Object Access Protocol messages are used to invoice the XML web services and receive data retrieved by the XML web services;
wherein each Simple Object Access Protocol message comprises a payload selected from the group consisting of: invocation parameters set by the client using the resource scheduling filter, data retrieved by the XML web services from the aggregate resource scheduling database and sent back to the client, and an appointment scheduling request that is sent directly from the client to the service provider scheduling software.

11. The system of claim 1, wherein the data that is retrieved from the aggregate resource scheduling database is displayed to the client as a browser-based web page.

12. The system of claim 1, wherein the data that is retrieved from the aggregate resource scheduling database is displayed to the client as a personal calendar agent.

13. The system of claim 1, wherein the resource scheduling filter comprises one or more of the following: a geographic location filter, a date/time filter, an industry segment filter, a service provider filter, a resource filter, a service type filter, and a service filter.

14. The system of claim 13, wherein the various filters that comprise the resource scheduling filter can be applied in any order.

15. The system of claim 13, wherein the date/time filter is applied by using date and time fields from a browser-based web page.

16. The system of claim 13, wherein the date/time filter is applied using a personal calendar agent.

17. The system of claim 13, wherein the date/time filter comprises a date/time range filter that allows the client to select a date and time range rather than a single date and time.

18. The system of claim 17, further comprising a list box that lists available appointments for a selected resource or resource/service combination when the client applies the date/time range filter.

19. The system of claim 13, further comprising a list box that lists appointments previously scheduled using the resource scheduling filter.

20. The system of claim 13, further comprising a list box that provides a view of all filters currently applied and allows the client to remove an applied filter by selecting a filter layer that is higher than that of the filter to be removed.

21. A method of scheduling appointments, comprising:
(a) compiling resource and service information, appointment schedules and service provider information in an aggregate resource scheduling database;
(b) applying filter criteria to identify available appointments;
(c) using a client-based resource scheduling filter to apply the filter criteria;
(d) generating filter results;
(e) sending the filter results to the client;
(f) wherein a service provider has been selected, and wherein the selected service provider has scheduling software, sending a scheduling request message directly from the client to the service provider scheduling software to schedule the appointment; and
wherein the filter criteria are applied by a client desiring to schedule an appointment; and
wherein the resource scheduling filter comprises one or more of the following: a geographic location filter, a date/time filter, an industry segment filter, a service provider filter, a resource filter, a service type filter, and a service filter.

22. The method of claim 21, further comprising notifying the client that the appointment cannot be scheduled as requested if the scheduling request message conflicts with data in the service provider database.

23. The method of claim 21, wherein each service provider has scheduling software, and
wherein the scheduling request message is formatted to appear as though it were created locally by the scheduling software in use by the service provider.

24. The method of claim 21, wherein updated scheduling information is transmitted from the service provider database to the aggregate resource scheduling database but not from the aggregate resource scheduling database to the service provider database.

25. The method of claim 24, wherein the scheduling information from the service provider database is data comprising a structure, and
wherein the aggregate resource scheduling database comprises a schema,
the method further comprising modifying the structure of data collected from the service provider database so that it conforms to the database schema of the aggregate resource scheduling database.

26. The method of claim 21, further comprising using XML web services to retrieve data from the aggregate resource scheduling database.

27. The method of claim 26, further comprising using Simple Object Access Protocol messages for communications between the aggregate resource scheduling database and the client and for communications between the client and the service provider scheduling software;
wherein each Simple Object Access Protocol message comprises a payload selected from the group consisting of: invocation parameters set by the client using the resource scheduling filter, data retrieved by the XML web services from the aggregate resource scheduling database and sent back to the client, and an appointment scheduling request that is sent directly from the client to the service provider scheduling software.

28. The method of claim 21, further comprising displaying the filter results to the client in a browser-based web page.

29. The method of claim 21, further comprising displaying the filter results to the client in a personal calendar agent.

30. The method of claim 21, wherein the filters that comprise the resource scheduling filter can be applied in any order.

31. The method of claim 21, wherein the date/time filter is applied by using date and time fields from a browser-based web page.

32. The method of claim 21, wherein the date/time filter is applied using a personal calendar agent.

33. The method of claim 21, wherein the date/time filter comprises a date/time range filter that allows the client to select a date and time range rather than a single date and time.

34. The method of claim 21, further comprising providing a list box that lists available appointments for a selected resource or resource/service combination when the client applies the date/time filter.

35. The method of claim 21, further comprising providing a list box that lists appointments previously scheduled using the resource scheduling filter.

36. The method of claim 21, further comprising providing a list box that provides a view of all filters currently applied and allows the client to remove an applied filter by selecting a filter layer that is higher than that of the filter to be removed.
